(19) United States
(12) Patent Application Publication
(10) Pub. No.: US 2008/0192736 A1
(43) Pub. Date: Aug. 14, 2008

(54) METHOD AND APPARATUS FOR A MULTIMEDIA VALUE ADDED SERVICE DELIVERY SYSTEM

(75) Inventors: Marwan A. Jabri, Tiburon, CA (US); Brody Kenrick, San Francisco, CA (US); Albert Wong, Rohnert Park, CA (US); Jianwei Wang, Larkspur, CA (US); David Jack, Fairford (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Dilithium Holdings, Inc., Petaluma, CA (US)

(21) Appl. No.: 12/029,146

(22) Filed: Feb. 11, 2008

Related U.S. Application Data
(60) Provisional application No. 60/916,760, filed on May 8, 2007.
(60) Provisional application No. 60/889,237, filed on Feb. 9, 2007.
(60) Provisional application No. 60/889,249, filed on Feb. 9, 2007.

(51) Int. Cl. H04L 12/66

(52) U.S. Cl. 370/352

(57) ABSTRACT

A multimedia multi-service platform for providing one or more multimedia value added services in one or more telecommunications networks includes one or more application servers configured to operate in part according to a service program. The platform also includes one or more media servers configured to access, handle, process, and deliver media. The platform further includes one or more logic controllers and one or more management modules.

### CROSS-REFERENCES TO RELATED APPLICATIONS

This application claims priority to U.S. Provisional Patent Application No. 60/889,237, filed on Feb. 9, 2007, the disclosure of which is hereby incorporated by reference in its entirety for all purposes. This application also claims priority to U.S. Provisional Patent Application No. 60/889,249, filed on Feb. 9, 2007, the disclosure of which is hereby incorporated by reference in its entirety for all purposes. Additionally, this application claims priority to U.S. Provisional Patent Application No. 60/916,760, filed on May 8, 2007, the disclosure of which is hereby incorporated by reference in its entirety for all purposes.

The following two regular U.S. patent applications (including this one) are being filed concurrently, and the entire disclosure of the other application is incorporated by reference into this application for all purposes:
Application No. , filed Feb. 11, 2008, entitled “Method and apparatus for the adaptation of multimedia content in telecommunications networks” (Attorney Docket No. 021318-006510US); and
Application No. , filed Feb. 11, 2008, entitled “Method and apparatus for a multimedia value added service delivery system” (Attorney Docket No. 021318-006610US).

### COPYRIGHT NOTICE

A portion of this application contains computer codes, which are owned by Dilithium Networks Pty Ltd. All rights have been preserved under the copyright protection, Dilithium Networks Pty Ltd. ©2008.

### BACKGROUND OF THE INVENTION

The present invention relates generally to methods, apparatuses and systems of providing media during multimedia telecommunication (a multimedia “session”) for equipment (“terminals”). The present invention also concerns the fields of telecommunications and broadcasting, and addresses digital multimedia communications and participatory multimedia broadcasting. The invention provides methods for introducing media to terminals that implement channel-based telecommunications protocols such as the Internet Engineering Task Force (IETF) Session Initiation Protocol (SIP), the International Telecommunication Union (ITU) Telecommunication Standardization Sector (ITU-T) H.323 Recommendation, the ITU-T H.324 Recommendation and other Standards and Recommendations derived from or related to these standards, which we call SIP-like, H.323-like or H.324-like. The invention also applies to service frameworks such as those provided by the Third Generation Partnership Project (3GPP) IP Multimedia Subsystem (IMS) and its derivatives, Circuit Switched Interworking (CSI), as well as networks based on Long Term Evolution (LTE) and 4th generation networks technologies (4G) regardless of the access technologies (e.g. UMTS, WiFi, CDMA, WiMAX, etc.).

FIG. 1 illustrates a conventional connection architecture for mobile-to-mobile H.324 calls. A simplified depiction of network elements involved in a typical 3G-324M session between two terminals is shown. A terminal originating a session/call (TOC), a terminal terminating a session (TTC), a mobile switching centre (MSC) associated with a TOC (OMSC) and an MSC associated with TTC (TMSC) are illustrated.

In a typical session where both TOC and TTC are in 3G coverage, a 3G-324M terminal (TOC) can have a video session with another 3G-324M terminal (TTC). A video session exchanges video and/or audio stream. However, if the TOC in a supporting 3G network originates a session to TTC which is in 2G-only coverage, in spite of its video capabilities, the attempt of the video session from A to B will not connect as a video session. In some cases, not even a reduced voice only session between the two terminals will be established.

From the above, it is seen that in a 3G network, in spite of inherent terminal and network capabilities for multimedia display, when TOC performs the steps described above, the media sent to TOC from the network is only conventional audio (voice) or no session at all. Thus, there is a need in the art for methods, techniques and apparatus for supplying multimedia content augmenting session media, such as providing video in addition to audio, to enhance user experience when communicating through various telecommunication protocols.

Present networks such as Third Generation (3G) mobile networks, broadband, cable, DSL, WiFi, WiMax networks, and the like allow their users access to a rich complement of multimedia services including audio, video, and data. These inherent capabilities are not exercised in most services and often a substantially sub-optimal experience is received.

Video Value Added Services: The typical user desires that their media services and applications be seamlessly accessible and integrated between services as well as being accessible to multiple differing clients with varied capabilities and access technologies and protocols in a fashion that is transparent to them. These desires will need to be met in order to successfully deliver some revenue generating services. The augmentation of networks, such as 3G-324M and SIP that are presently capable of telephony services but not sharing services is one such example. Further, the effort to deploy a service presently is significant. The creation of an application requiring specific system programming tailored for the service which cannot be re-used in a different service causing a substantial repetition in work effort. For each application, there may be proprietary connections to a separate media gateway or media server which further leads to service deployment delays and integration difficulties. The lack of end to end control and monitoring also leads to substantially sub-optimal media quality. Thus, there is a need in the art for apparatus, methods and systems for offering video value added services to fulfill user desires.

Participatory Multimedia Value Added Service: Present broadcasters offer a variety of offerings in audio and video as well as interactive features such as video on demand. More recently some broadcasters have increased their levels of interaction to allow for greater audience participation and to allow influence on the program such as voting via SMS (short messaging system messages a.k.a. text messages) and depositing MMS (multimedia system message) for inputs. Generally this influence is limited to non real-time influence, and is often not acted upon until a later broadcast show (e.g. days later). The disparity between the multimedia characteristics available for use in telecommunications and broadcasting creates many barriers to the ease of sharing information material among users, between users' devices and for services and broadcasting. The typical user desires that their media be seamlessly accessible by another user and to multiple differing clients with varied capabilities and access technologies and protocols. The augmentation of networks, such as 3G-324M, that are presently capable of telephony services but not of broadcast services is one such example.

Thus, there is a need in the art for improved methods and systems for receiving and transmitting multimedia information between multimedia telecommunications networks and devices and broadcasting networks and environments, and in particular between advanced capability networks, such as 3G/3GPP/3GPP2/3.5G/4G networks and wireless IP networks, and terrestrial, satellite, cable or internet based broadcast networks associated generally with television (e.g. TV and/or IPTV). In particular, a greater level of interaction and participation in programs broadcast via a television network/broadcaster is desired in order to increase subscriber satisfaction and increase audience retention, which may be achieved through greater immersion.

### SUMMARY OF THE INVENTION

According to an embodiment of the present invention, an apparatus and methods and techniques for supplying video value added services in a telecommunication session is provided. Embodiments also provide services and applications provided by a video value added service platform. More particularly, the invention provides a method and apparatus for providing video session completion to voice session between terminals that sit in 3G networks and 2G voice-only networks and implement channel-based media telecommunication protocols.

Further, the invention makes access to participatory multimedia broadcasting seamless from an InterActor's perspective. Embodiments of the present invention have many potential applications, for example and without limitations, quiz shows, crowd sourcing of content such as news, interviews, audience participation, contests, “15 seconds of fame” shows, talk back TV, and the like.

A multimedia multi-service platform for providing one or more multimedia value added services in one or more telecommunications networks is provided. The platform includes one or more application servers configured to operate in part according to a service program. The platform also includes one or more media servers configured to access, handle, process, and deliver media. The platform further includes one or more logic controllers and one or more management modules.

Further embodiments provide a system adapted to provide video value added services, the services being provided to one or more devices, wherein the one or more devices comprise either mobile wireless devices or broadband devices, the system comprising a media server; a SIP server responsive to one or more programmed commands; a multimedia transcoding gateway; and a service creation environment, wherein the system is adapted to receive DTMF/UII inputs and is adapted to receive RTSP media content. This system can be further adapted to provide a video call completion to voice service from a first device to a second device, wherein the first device supports a first media type supported at the second device and a second media type not supported at the second device.

Many benefits are achieved by way of the present invention over conventional techniques. For example, embodiments of the present invention provide for the incorporation of multimedia information communicated over 3G telephone networks in a broadcast program. In a particular embodiment, a 3G telephone connects to a server by dialing a telephone number and, possibly after navigating an interactive menu, transmits an audio/video stream to the server, which then processes the stream for delivery into a mixing environment associated with broadcasting the program. The mixed multimedia that will be used for the broadcasting can be fed back to the user. Further, embodiments provide for more true interactivity allowing for a more reactive/spontaneous ability and willingness in contributors to a broadcast. Further embodiments provide for an integrated overall participatory service that is more manageable, easily produced and less costly to operate.

Depending upon the embodiment, one or more of these benefits, as well as other benefits, may be achieved. The objects, features, and advantages of the present invention, which to the best of our knowledge are novel, are set forth with particularity in the appended claims. The present invention, both as to its organization and manner of operation, together with further objects and advantages, may best be understood by reference to the following description, taken in connection with the accompanying drawings.

### BRIEF DESCRIPTION OF THE DRAWINGS

FIG. 1 illustrates a conventional connection architecture for mobile H.324 calls;

FIG. 2 illustrates a connection architecture for mobile H.324 video session completion to 2G mobile voice or fixed-line PSTN voice according to an embodiment of the present invention;

FIG. 3 illustrates session establishment for a media server and a media generator according to an embodiment of the present invention;

FIG. 4 illustrates a simplified call flow illustrating a sequence of session operations according to an embodiment of the present invention;

FIG. 5 illustrates a simplified network architecture and session connection diagram illustrating session operations according to an embodiment of the present invention;

FIG. 6 illustrates a simplified network architecture according to an embodiment of the present invention;

FIG. 7 illustrates a high level ViVAS architecture and the interfaces to ViVAS components and supporting application services according to an embodiment of the present invention;

FIG. 8A illustrates a ViVAS architecture according to an embodiment of the present invention;

FIG. 8B illustrates a ViVAS architecture according to another embodiment of the present invention;

FIG. 9 illustrates a type of connection architecture of CSI video blogging over the ViVAS platform according to an embodiment of the present invention;

FIG. 10 illustrates an overall call flow of a CSI video blogging according to an embodiment of the present invention;

FIG. 11 illustrates a call flow of a CSI video blogging involving IWF according to an embodiment of the present invention;

FIG. 12 illustrates the interfaces between all key components for supporting CSI applications over the ViVAS platform according to an embodiment of the present invention;

FIG. 13 illustrates a session connection of video MMS service according to an embodiment of the present invention;

FIG. 14 illustrates a session connection of video chat with animated video avatar according to an embodiment of the present invention;

FIG. 15 illustrates a call flow of establishing a video chat session according to an embodiment of the present invention;

FIG. 16 illustrates a type of connection architecture of video karaoke service over the ViVAS platform according to an embodiment of the present invention;

FIG. 17 illustrates a type of connection architecture of video greeting service over the ViVAS platform according to an embodiment of the present invention;

FIG. 18 illustrates a network diagram showing the three screens with media flow in relation to a participation TV platform according to an embodiment of the present invention;

FIG. 19 illustrates a single platform offering multiple services according to an embodiment of the present invention;

FIG. 20 illustrates various connections between various elements according to an embodiment of the present invention;

FIG. 21 illustrates a simplified network diagram for a service offering participatory multimedia according to an embodiment of the present invention;

FIG. 22 illustrates capturing and broadcasting and feeding back to an InterActor according to an embodiment of the present invention;

FIG. 23 is a connection diagram showing inputs and outputs according to an embodiment of the present invention;

FIG. 24 is a connection diagram showing interfaces according to an embodiment of the present invention;

FIG. 25 illustrates a broadcast layout according to an embodiment of the present invention;

FIG. 26 illustrates a broadcast layout for two captured streams of Scene A and Name A at a participating device according to an embodiment of the present invention;

FIG. 27 is a simplified flowchart illustrating a method of providing a participatory session to a multimedia terminal according to an embodiment of the present invention;

FIG. 28 illustrates a call flow for providing an avatar according to an embodiment of the present invention;

FIG. 29 illustrates a call flow for providing an avatar according to an embodiment of the present invention; and

FIG. 30 illustrates a network for providing avatars according to an embodiment of the present invention.

### DETAILED DESCRIPTION OF SPECIFIC EMBODIMENTS

Specific embodiments of the present invention relates to methods and systems for providing media that meets the capabilities of a device when it is communicating with a less able device (at least in a single respect) and hence providing a more satisfying experience to a subscriber on the more able device. In a specific scenario involving a video capable multimedia device, e.g. 3G videophone, communicating to any type of voice only call, the invention allows for session completion to a device that would otherwise be deemed unreachable or off network. The session completion is augmented with media in a communication session in channel-based media telecommunication protocols with media supplied into channels of involved terminals based on preferences of an operator, originator and receiver.

More specifically, embodiments relate to a method and apparatus of providing configurable and interactive media at various stages of a communication session in channel-based media telecommunication protocols with media supplied into channels of involved terminals based on preferences of an operator, originator and receiver.

Additional embodiments provide a Participation TV application which enhances the consumer TV experience by enabling a user to interact in various forms with TV content. We call this participating and interacting user an “InterActor”, to highlight both their interactive role and their contribution to the show which is much akin to the paid studio actors.

Interactive television represents a continuum from low interactivity (TV on/off, volume, changing channels, etc) to moderate interactivity (simple movies on demand with/without player controls, voting, etc) and high interactivity in which, for example, an audience member affects the show being watched (feedback via a set top box [STB] vote button or SMS/text voting).

The present invention provides, for consumers, a coherent and attractive interactivity with TV/broadcast programs and for broadcasters, a tremendous opportunity to differentiate from their competition by proposing the most advanced TV experience, create new revenue streams and increase ratings, increase the audience participation and retention as well as individuals dwell time, develop communities around shows/series/themes/etc and gather substantial viewer information by not only recognizing their contributions, but also identifying their means of connecting and any feedback they provide (either intentionally or as associated with their access mechanism).

The present invention also offers the opportunity for video telephony to evolve from inter-personal communications to a rich media environment via the content continuously generated from TV channels.

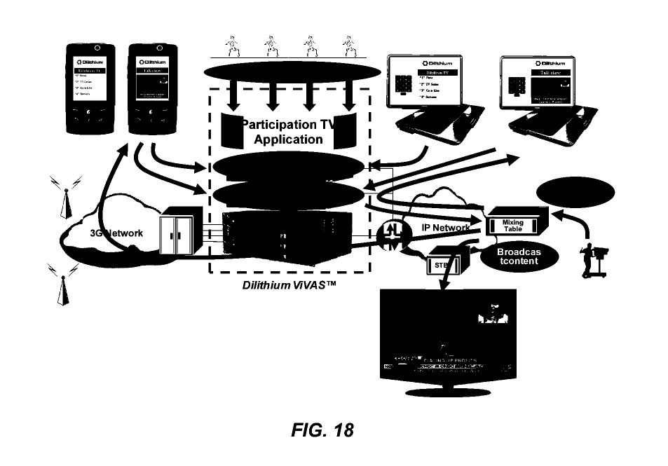

The present invention is applicable to the “three screens” of communication. The three screens are Mobile, PC and TV screens with different and complementary usages. FIG. 18 illustrates a network diagram showing the three screens in relation to a participation TV platform. The present invention addresses the markets of multimedia terminals, such as 3G handsets (3G-324M) and packet based devices, such as SIP-based or IMS based devices (MTSI/MMTel, WiFi phone, PC-client, hard-phone, etc) and proposes to accelerate multimedia adoption and provide a unique experiences to consumers.

An embodiment provides video to augment the media supplied to a video device when communicating with an audio only device (or a device temporarily restricted to audio only). The provided video is typically an animation, generated through voice activity detection and speaker feature detection with the generated video supplied into channels of involved terminals based on preferences of an operator, originator and receiver.

Merely by way of example, this embodiment is applied to the establishment of multimedia telecommunication between a 3GPP 3G-324M (protocol adapted from the ITU-T H.324 protocol) multimedia handset on a 3G mobile telecommunications networks and a 3GPP 3G-324M multimedia handsets on 2G mobile telecommunication networks or various voice only handsets on 2G mobile telecommunication networks or fixed-line phones on PSTN or ISDN networks, but it would be recognized that the invention may also include other applications.

In the IMS architecture, the ViVAS engine can be seen as the integration of an application server (AS) and a media server (MRF), which is fully configurable and is running application scripts. The present invention may follow this integration or may be distributed across other components of both the IMS and also other architectures.

Video Value Added Services (ViVAS) according to an embodiment of the invention include a hardware and software solution that enables a broad range of revenue making video value added services to and from mobile wireless devices and broadband terminals. ViVAS solutions include a media server, a SIP server, a multimedia transcoding gateway, and a comprehensive service creation environment. In alternative embodiments, other functional units are added and some of the above functional units are removed as appropriate to the particular application. One of ordinary skill in the art would recognize many variations, modifications, and alternatives.

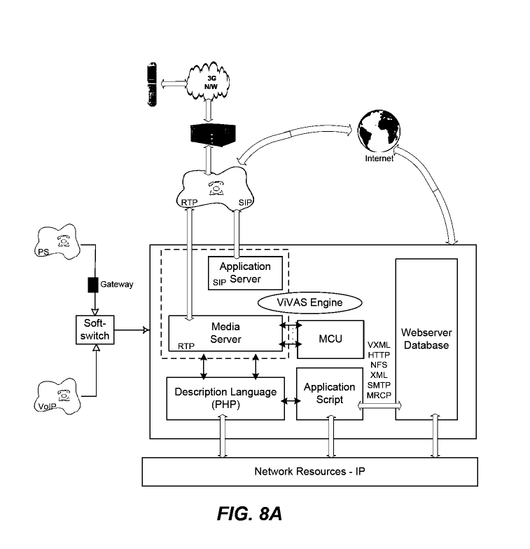

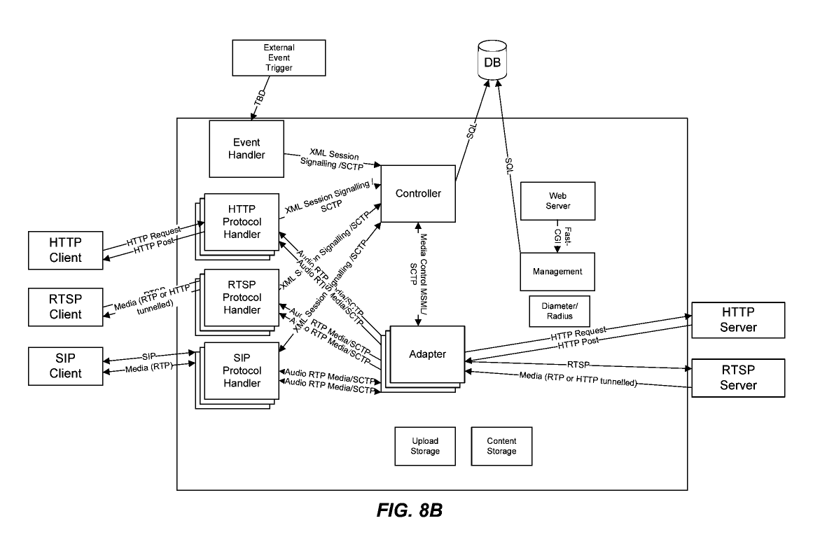

FIG. 8A illustrates a composition of a ViVAS platform according to an embodiment. The ViVAS platform comprises a ViVAS engine that includes a SIP-based application server and media server for processing and generating media over RTP. The application server and the media server can be physically co-located, or separated in a decomposed architecture. There can be multiple media servers connected to one application server. Multiple application servers can exist in the same ViVAS platform primarily for the system redundancy configuration. Services are driven at the application server and are programmable in the form of application scripts. One embodiment primarily uses PHP scripts. ViVAS embodiments comprise an MCU (multipoint control unit) that provides media mixing functions for supporting application services such as video conferencing and video session completion to voice. ViVAS embodiments also include a web server and a database that provides application support and management functionalities. In addition, a ViVAS platform optionally includes a multimedia gateway that bridges connectivity between differing networks, such as bridging the packet-switched and circuit-switched networks. The multimedia gateway used can be a DTG (Dilithium Transcoding Gateway). This allows connection with a 3G network in order to connect with mobile users. A ViVAS platform also allows connectivity from a packet-switched connection to a packet-switched connection with a service provided by the ViVAS engine and is compatible with IMS infrastructure. Connectivity to other packet based protocol such as the Adobe Macromedia Flash protocol (RTMP or RTMP/T) is also possible through the inclusion of protocol adaptors for RTMP or RTMP/T and the appropriate audio and video protocols.

The ViVAS signaling server is a high performance SIP user agent. It is fully programmable using a graphical editor and/or PHP scripting; it can control multiple ViVAS media servers to provide interactive voice & video services. The signaling server features include SIP user agent, media server controller, MRCP ASR (Automatic Speech Recognition) controller, RTP proxy, HTTP and telnet console, PHP scripting control, rapid application development, Radius, Text CDR and HTTP billing, and overload control.

The ViVAS media server is a real-time, high capacity media manipulation engine. The media server features include RTP agent, audio codecs including AMR, G711 A and g law, G729, video codecs including at least one of H263, MPEG4-Part2 and H.264 (or MPEG4-Part 10), media file play and record for supporting formats in at least AL/UL/PCM/3GP/JPG/GIF, 10 to 100 ms packetization with 10 ms increment, in-band and RFC 2833 DTMF handling, T38 FAX handling, and buffer or file system for media recording.

The ViVAS media server can transform a codec to another codec, through various transcoding options. The transcoding, along with other general transcoding functions also available such as transrating and transizing bring maximum flexibility in deployment.

The media server communicates using a TCP port with the signaling server. A media server is active on one signaling server at a time, but can switch to another server if the active server fails. Two modes of operation are possible: One mode is standard mode where the media server switches signaling server on active server failure only. Another mode is advanced mode, where the server numbered “1” is the main server. When it fails, the media server activates the next one. When the main server is back on line, the media server re-activates it and re-affects the resources to the main server when they are freed by the backup server. The media server uses a keep-alive mechanism to check that the connection with the signaling server is up.

The present invention is provided as a toolkit for ViVAS enabling service providers to bring consumers innovative multimedia applications with substantially reduced effort.

Services and applications can be created using a graphical user interface which provides an easy to use, drag and drop approach to creating video menus, and/or PHP scripting, featuring interactive DTMF based video portals, and linking from menus and portals to revenue generating RTSP streaming services such as pay per view clips, live and pre-recorded TV, video surveillance cameras, other video users, voice only users and more. Services can also be scripted a scripting language programmatically.

ViVAS also enables video push services, which allow the network to make video calls out from the server to a 3G phone, circuit switched or packet switched, or broadband fixed or wireless users using SIP/IMS. This enables subscription based video, network announcements, and a host of other applications. ViVAS is compatible with all major voice and video standards used in 3G and IP networks.

ViVAS complies to system standards and protocols including, but not limited: RFC 3261, 2976, 3263, 3265, 3515, 3665, 3666 (SIP), RFC 2327, 3264 (SDP), RFC 3550, 3551, 2833 (DTMF), 3158 (RTP), RFC 2396, 2806 (URI), RFC 2045, 2046 (MIME), RFC 2190, and Telcordia GR-283-CORE (SMDI).

The system accepts a number of interfaces including 3G-324M (including 3GPP 3G-324M and 3GPP2 3G-324M), H.323, H.324, VXML, HTTP, RTSP, RTP, SIP, SIP/IMS.

The system database can be Oracle, mySQL, or Sybase or another database. The management interfaces support Radius, SNMP, HTTP and XML. The media codec supported in the system include GSM-AMR, G.711, G.723.1, G.726, G.728, GSM-AMR WB, G.729, AAC, MP3, H.263, MPEG4 Part 2, H.263, H.264 and 3GPP variants.

ViVAS has an intuitive visual interface. The ViVAS service creation environment is available through the web to any user, even those with limited programming skills. ViVAS allows fast IVR creation and testing; for example, no more than an hour for creating standard games and switchboard applications. Linking phone numbers to applications can be performed in one single click. Management of options and sounds/video of the applications can be performed. Users can be authorized to make updates according to a set of rights. The system allows for easy marketing follow-up through a statistics interface that exposes in detail the usage of the system.

The management system allows accurate distinction between beginners, advanced users and experts. Thanks to the PHP scripting, PHP developers can implement their own modules and add their modules to the system, making them able to create and manage almost any kind of IVR applications. ViVAS technologies allow advanced IVR applications based on new IP capabilities such as: customized menus, dynamic vocal context, real time content, vocal publishing, sounds mixed over the phone, and video interactive portals.

ViVAS integrates “Plug and Play” IVR building blocks and modules. The blocks and modules include different features and functions as follows: customized menu (12 key-based menu with timeout setting), prompt (playing a sound or video), sound recording, number input, message deposit, session transfer rules, SMS/email generation, voice to email, waiting list, time/date switch, gaming templates, TTS functions, database access, number spelling, HTTP requests (GE and POST), conditional rules (if, . . . ), loops (for, next, . . . ), PHP object, FTP transfers (recorded files), voice recording, videotelephony, bridging calls, media augmentation, user selected and live talking avatars, video conferencing, outgoing calls, VXML exports, winning session (game macro module), etc.

The user management in ViVAS has five different levels: administrator, integrator, reseller, user and tester. Modules authorization is at user level. ViVAS also has an outgoing calls credit management feature.

The phone and call management is an outgoing session prepaid system which includes integrated PSTN map, user credit management, automatic session cut. The system is easy to use for assigning phone numbers, and is not limited to phones for a user and for an application.

The application management has a fully “skinnable” web interface and also allows multi-language support. It has also unlimited number of applications per user. Further, the application management has dynamic application with variables stacks and inter-calls data exchange. It produces explicit, real-time errors reporting

The video editor is based on a Macromedia Flash system. It has a drag ‘n’ drop interface, the ability to link & unlink objects by simple mouse clicks, WYSIWYG application editing process, fast visual application tree building, 100% customizable skin (icons & color), link phones inside the application editor, zoom in, zoom out and unlimited working space.

The XML provisioning interface has user management (create, get, modify, delete), user rights (add / remove available modules), statistics and reporting XML access (get), and phone numbers (create, assign, remove, delete).

ViVAS has numerous applications, including live TV, video portal, video surveillance, video blogging, video streaming, video push services, video interactive portal, video session completion to voice, interactive voice and video response (IVVR), music jukebox, video conferencing over mobile or fixed line network, video network messages, video telemarketing, video karaoke, video call center, video ring, video ringback (further described in U.S. patent application Ser. Nos. 11/496,058, 11/690,730, and 60/916,760, the disclosures of which are hereby incorporated by reference in their entirety for all purposes), video greeting, music share over voice, background music, video SMS, video MMS, voice IVR with video overlay, IMS presence, multimedia exchange services (further described in U.S. patent application Ser. Nos. 11/622,951, 11/622,999, and 11/622,965, the disclosures of which are hereby incorporated by reference in their entirety for all purposes) text messaging to MMS, flash proxy, participation TV, and combination service interconnection (CSI) based applications such as video blogging and video chat including anonymous video chat. ViVAS provides a platform to create many other types of applications due to the availability of flexible the service creation environment.

ViVAS service creation environment enables a wide variety of applications to be easily customized using a web GUI and PHP scripting. The service environment is SIP-based which enables access to hosted applications from any SIP device. The feature of complete session statistics/reports can be web-based and can support a full suite of logging, application specific statistics and user data storage, data mining and CVS export. The statistics can enable fine analysis of consumer behavior and measurement of program success. ViVAS supports multiple languages through unicode and uses English as default language. Further, ViVAS integrates advanced media processing capabilities including on the fly and real-time media transcoding and processing. It provides unique features which provide minimal delays and lip-synch (using intelligent transcoders which are further described in U.S. Pat. Nos. 6,829,579, 7,133,521, and 7,263,481, and U.S. patent application Ser. Nos. 10/620,329, 10/693,620, 10/642,422, 10/660,468, and 10/843,844, the disclosures of which are hereby incorporated by reference in their entirety for all purposes), fast recovery from video corruption (using Video Refresh which is described in U.S. patent application Ser. No. 10/762,829, the disclosure of which is hereby incorporated by reference in its entirety for all purposes) an ability to perform media cut over when changing streams to ensure that all new video streams begin with an intra coded frame, even when the source at cutover time has not presented an intra coded frame and fast video session setup time (MONA/WNSRP).

The advanced features of ViVAS bring a number of benefits to existing service providers, operators, investors, and end-users. It can improve ARPU with new revenue generating services and promote video usage among existing mobile phone users. With open service description technologies, ViVAS provides a robust carrier grade solution with scalability to multi-million user systems with reduced time to market with ready to use and flexible programming environment. It promises rapid content deployment with ability to dynamically change video content based on choices made by the user interacting with the content, thus it strengthens subscriber royalty and enhances an operators ability to monetize niche services. It provides IMS infrastructure integration accessible by 2.5G/2.75G/3G/3.5G/LTE/4G mobile, wireline/wireless broadband and HTTP.

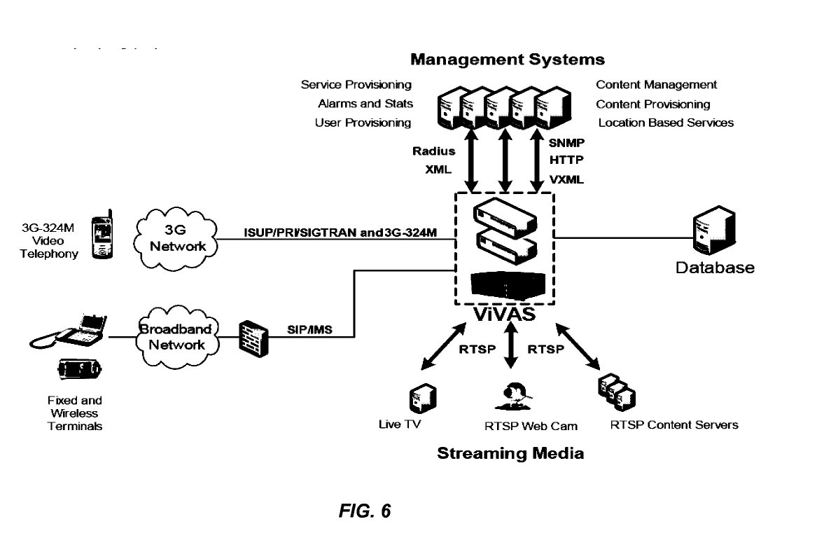

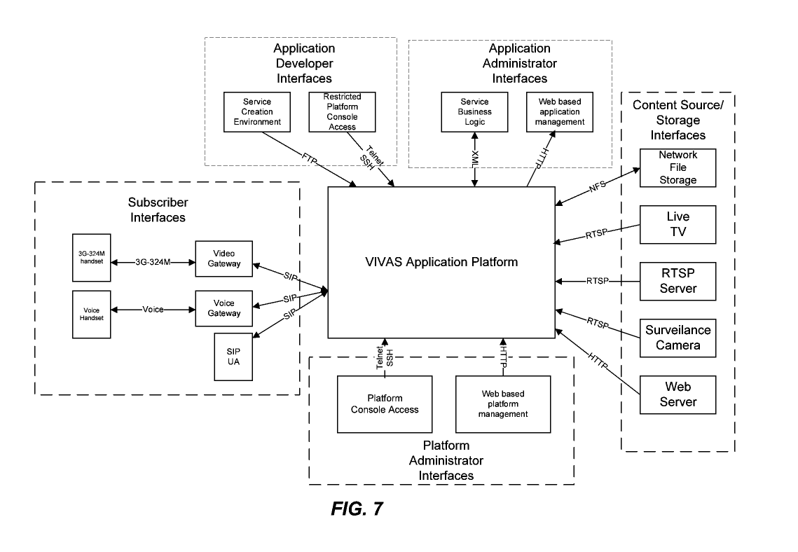

ViVAS offers a man-machine and machine-machine communication service platform. Various embodiments of the present invention for a video value added service platform have varying system architectures. FIG. 6, FIG. 7, FIG. 8A, and FIG. 8B show a variation of possible embodiments of ViVAS architecture. Some embodiments include additional features such as content adaptation as described more thoroughly in co-pending U.S. Patent Application No. (Attorney Docket No. 021318-006510US) and offer additional clients services such as the ability to provide value added services to RTSP or HTTP clients.

Another embodiment may include but not be limited to one or more of the following functions and features: Java and Javascript support for the service control and creation environment (for example JSR 116 and JSR 289); intelligent mapping of phone numbers for call routing with additional business logic; open standard or proprietary common programming language interface (e.g. ViVAS API) for defining service applications; integrated video telephony interface (e.g. circuit-switched 3G-324M, IMS, etc.); content storage and database management (e.g. for supporting ad overlay, ad insertion, billing functionalities, the media recorded by end-users/InterActors connecting to the service, etc.); menu management providing a natural and easy way to browse through the different options just by using DTMF; real-time and high-quality streaming of live cameras, live TV programs, stored media files, etc with fast stream change using DTMF; ACD (Automatic Call Distribution) enabling the selection, done by production assistants/moderators, of people who will intervene during the show; ACD allows mechanisms such as queuing, waiting room, automated information collection, automated questioning and answering, etc.; video and audio output to mixing table (SDI[Serial Digital Interface], S-Video/Composite, HDMI[high definition multimedia interface], and others) enabling the real-time intervention/interaction of people during the shows; Easy introduction by reusing the existing network mechanisms/services such as billing, routing, access control, etc; user registration and subscription server; and content adaptation.

ViVAS provides intelligent mapping of phone numbers for call routing and is capable of routing calls in a more advanced manner than conventional call routing does. The conventional call routing is commonly performed at an operator's network equipment such as MSC. The conventional call routing is a simple logic which is a direct phone number mapping to the target trunk. ViVAS mapping of a phone number does more by routing the call to different destination or application service based on the one or more of the originating phone number, the terminating phone number (or the MSISDN), the date and time of the call, the presence status of the person status in association with the MSISDN, a geographic location, etc. This enables enrichment of phone services with a tailoring of the phone services for both the phone users and the service providers.

Embodiments provide a Video Session Completion to Voice Session application. 3G-324M mobile networks successfully provide video communications to users. However, 3G users experience some video calls that cannot be successfully established. Most of these unsuccessful cases happen when the callee (a) is unreachable, busy, not answering; (b) has handset switched-off, (c) is not a 3G subscriber; (d) is not in 3G coverage; (e) is roaming in a network that doesn't support video calls, (f) has no subscription for video calls, (g) doesn't want to answer video calls, (h) has an IP voice only terminal.

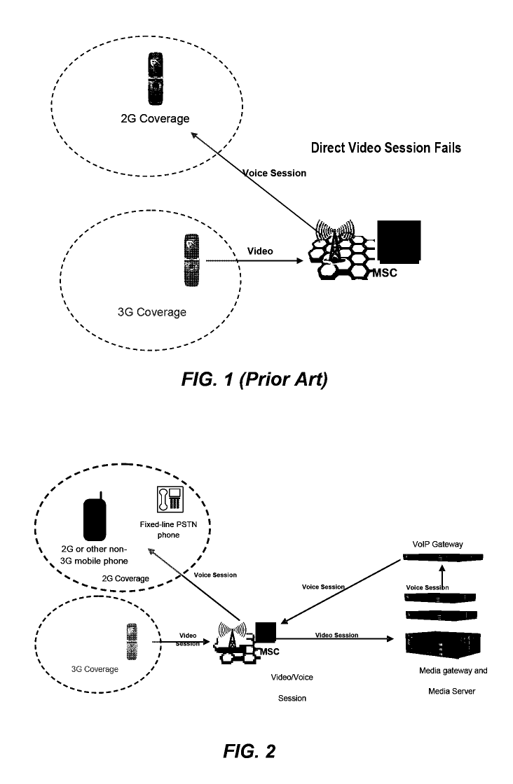

FIG. 1 illustrates a situation in which one of cases in the above unsuccessful session cases could occur. A 3G mobile handset A makes a video session to a 3G mobile handset B. The handset B is roaming in a network that doesn't support video calls. Thus the video session originating from A to B fails. In order to overcome this kind video session failing problem, a video session completion solution system may be created as an embodiment of the present invention.

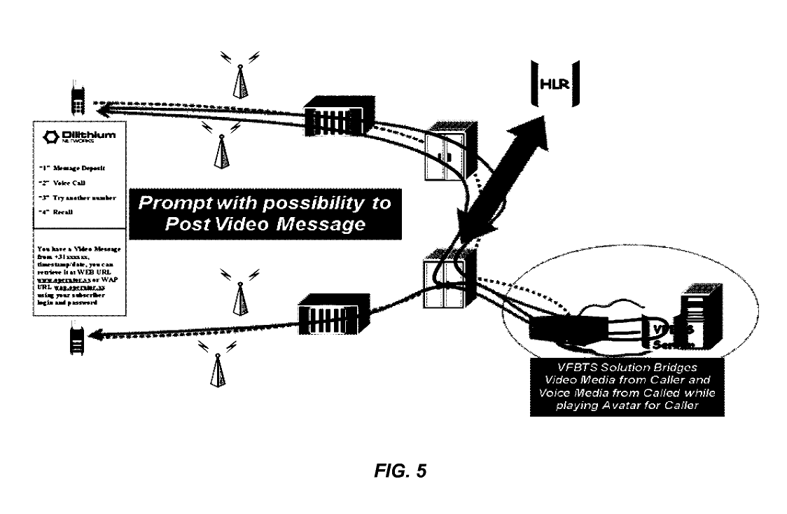

FIG. 5 illustrates a system configuration for video session completion to voice session. It contains several ViVAS components, multimedia gateways, media servers, media generators, and voice gateways. Physically, these components may be integrated on one system. For an example, the multimedia gateway can also function as a voice-only gateway. The media servers and media generators may run on the same computer system. All components may also be collocated.

The video session completion to voice also allows completion to 2G mobile terminals mobile networks, fixed-line phones in PSTN networks, or IP terminals with voice only capabilities, such as video camera not available or bandwidth limited. It would also be applicable to a pair of devices that could not negotiate a video channel, even with transcoding capabilities interposed. FIG. 2 shows the video session completion to voice for 2G mobile networks and PSTN networks.

The terminal A originates a video session to the terminal B. The mobile switch center (MSC) finds that the terminal B is not covered in a 3G network, yet it is covered, for example, by a 2G network. Recognizing this it forwards the video session to the ViVAS platform. In some embodiments, the ViVAS platform may always be directed to access any of a number of supported services. To complete the video session to the voice terminal, the ViVAS platform first performs transcoding through a multimedia gateway. The transcoding may involve voice, video, and signaling transcoding or pass-through if necessary. ViVAS then forwards the voice bitstream, directly or indirectly, to the 2G networks that terminal B is in through a voice gateway.

As the session is bidirectional, terminal A should receive a video session, ostensibly from terminal B. The media generator in the ViVAS platforms generates media and sends generated video bitstreams to terminal A. The generated video bitstreams can be a video clip from media content servers, or can be terminal B's video ring tone stored on a content server, or can be an animation cartoon provided by some third party video application tools (via various protocols e.g. MRCP, or RTSP or other standard or proprietary protocols).

When unsuccessful in connecting to Terminal B, ViVAS can offer options to Terminal A to leave a video message to Terminal B to be retrieved by, or delivered to, the user of Terminal B at a later time by, for example by MMS, email, RSS or HTTP. ViVAS can also offer Terminal A an option to callback after a specified period of time duration, or when Terminal B becomes available for receiving calls (indicated via presence information or other).

Further, the generated video bitstream during the session can be an animation cartoon or avatar, including static portraits, prerecorded animated figures, modeled computer generated representations and live real-time figures. The animated cartoon can be generated in real-time by voice detection application tools and feature detection application tools. For example, it can use gender detection through voice recognition. It can also have age detection through voice recognition for automatic animation cartoon or avatar selection. The voice detection application tool, voice feature detection application tool, and video animation tool can be part of media generator and run on the ViVAS platform.

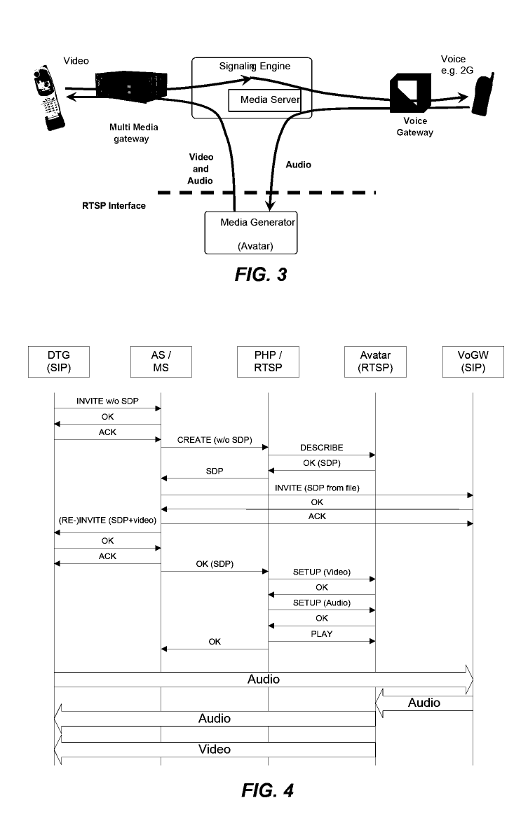

FIG. 3 shows an exemplary architecture of the ViVAS platform for video session completion to voice. The architecture contains a multimedia gateway, a signaling engine, a media generator, a voice gateway, and optionally a media server. The incoming multimedia bitstream from terminal A is forwarded to the media server through the multimedia gateway sitting at the front. The media server continues the incoming bitstream and outputs incoming voice bitstream to a 2G terminal through the voice gateway. The outgoing voice bitstream from the ViVAS platform may be transcoded as necessary based on the applications and devices in use. The illustrated architecture is scalable such that it can have one or more multimedia gateways, zero or more media servers, one or more media generators, and one or more voice gateways. Additionally, the architecture may include zero or more signaling proxies and zero or more RTP proxies.

In the reverse direction of 2G/voice to 3G, the incoming bitstream from the 2G terminal has only a voice bitstream. The voice bitstream is sent to a media generator through the voice gateway and media server. The media generator generates video signals which can synchronize with incoming voice signals, by recognizing features in the speech. The generated video signals combined with voice signals are output to the 3G terminals through the signaling engine or media server to the multimedia gateway, or directly to the multimedia gateway as necessary. Thus, ViVAS completes the feature of video session completion to voice.

FIG. 4 is a simplified sequence diagram illustrating operations according to an embodiment of the present invention. The component DTG is a multimedia gateway. The AS is a media server or an application server with or without a media server. The PHP/RTSP is application interface and media protocol in ViVAS, the avatar is a media generator. The VoGW is a voice gateway. The flowchart shows internal ViVAS session operations between each component. The session protocol in ViVAS is SIP, and DTG and VoGW on the ViVAS platform sides are also based on SIP.

Additionally, FIG. 4 illustrates a sequence of session operations between a media server and a media generator according to an embodiment. The session generates a video bitstream through a media generator avatar, based on an incoming voice bitstream/signal. The media server first sends a DESCRIBE to the media generator. The media generator replies OK messages to the server. Then the media server tries to set up the stream necessary. The media generator replies OK with session description protocol (SDP) with information of media types and RTP ports. The media server sends setup with push audio to the media generator, and the media generator replies OK. The video and voice session is setup between media server and media generator after the messaging of play and reply. The session protocols between media server and media generator can be SIP, or H.323 or others.

Inside the ViVAS platform, the DTG performs media transcoding from a 3G network side to SIP. It sends an INVITE message to the media server. Then the media server sends a CREATE message establishing up the interface between media server and avatar. Once the media server gets OK and SDP messages from the avatar, it sends INVITE with SDP to the voice gateway. The voice gateway sends OK messages to media server once it gets reply from voice-only networks outside. The media server sends back ACK message to voice gateway and it sends a number of messages RE-INVITE, SDP, video mobile detection and the like, which are necessary for a video session setup. The DTG sends OK back to media server once the video session is set up. The media server sends OK to the PHP/RTSP. The interface PHP/RTSP starts to send video SETUP, audio SETUP, and PLAY messages to media generator. Once media generator is ready to create video to media server, the media session is established. The DTG and the voice gateway have audio and video channel setup. The audio of incoming media signals from 3G networks go to voice gateway from DTG. The incoming audio signals from voice only networks go to the media generator and then the generated video combining the audio go to the DTG.

It would also be suitable to use the setup and service described to provide media not only for the case of session completion but also to provide video to a subscriber retaining video coverage when a partner intermittently loses video coverage and drops back to voice with a voice session continuity (VCC) function, such that an end-to-end video session changes to and back from video generated/avatar voice session.

In addition to the previously described examples, embodiments of the present invention supply session media in the form of mixed media. For example, ViVAS may provide a mixed content (themed) session. Content is provided by media server. In these applications, some part of, or all, session media could form a part of streamed and interactive content. In its simplest form, replacement or adjunct channels could be supplied by ViVAS inside a more capable network for people dialing in from, or roaming into, single media only networks (or otherwise capable networks). A stream may also be an avatar, a computer generated representation, possibly personalized representing a calling party that is designed to move its mouth in time with an audio only signal. When avatars are employed, the avatars may be changed by user commands such as a feature of switching the avatar using DTMF keys or a voice command issued to an IVR or via HTTP interface. The avatar may be automatically selected using gender detection from voice (e.g. voice pitch) to select an appropriate avatar, for example for the gender of the avatar. Alternatively, special avatars that are gender neutral may be selected. The voice in the session may also be modified (morphed) to change personality. Additionally, age detection may be performed from voice to select appropriate avatar. If multiple voices are detected, or if a number of conferees is known, the system may use multiple avatars and may display them singly or jointly on screen and only animate the particular user that is speaking at a time.

A user can associate an avatar with an MSISDN during a session via a control menu or may set the avatar or prior using profile setting. Additionally, the avatars may be modified in session by various factors, in a pre-configured manner or automatically, including but not limited to user control. Other aspects may be modified in session as part of a larger game, enticing users to remain in a session longer and hence drive minutes. Also, the interactions may modify features of an avatar, such as clothes that are being worn, or the colors of clothes or skin. If changes are made, the user may save the avatar for the next time, and this saving may be performed automatically. The avatar may get refined during conversation, especially if more characteristics are determined, or if additional or changing information are recognized, for example, position location may modify the clothes of a user. An avatar may also morph with time to another avatar. If, for example, gender detection was available, an avatar may begin a session androgynous and then if a male user was speaking, it may morph to take on more masculine features. Likewise the avatar may morph from androgynous to female. The media offered may be visual advertisements instead of an avatar. If advertisements are viewed, a tariff reduction or payment may be offered. A user may even interactively gain credit if they are running short by switching to hear audio and/or visual input or advertisement and put the remote on hold and switch back afterwards. As will be evident to one of skill in the art, adjunct channels are not limited to augmenting video only, but including replacement of any missing media, or logical channel, or other features as available.

ViVAS provides a conversion facility to convert any kind of media terminated at the ViVAS platform, that might otherwise need to be discarded, and convert it to a form usable in the lesser able device. For example, when video session completion to voice is active, video may still be being transmitted to ViVAS and ViVAS may capture one or more frames and transmit them as an MMS or clip for presentation on the screen. Analysis of the video may also provide information that might be usable for overlaying on the audio track or provided as text/SMS, for example, if users become very comfortable with the video medium then they may inadvertently find themselves nodding an affirmation. This information would otherwise be lost, but if detected, then a voice over could indicate to the voice only user that such event has occurred. Also, the message could be provided over a text channel.

Additionally, the ViVAS platform using voice recognition might render a text version of the conversation to the screen, either in the video as an overlay, or into text conversation. This would be applicable in noisy places where it is difficult to hear or in quiet places where it is desirable to not disturb others.

According to embodiments a system is provided and adapted to complete a call from a first device to a second device, wherein the first device supports a first media type supported at the second device and a second media type not supported at the second device. The system is where the first media type is voice and the second media type is video.

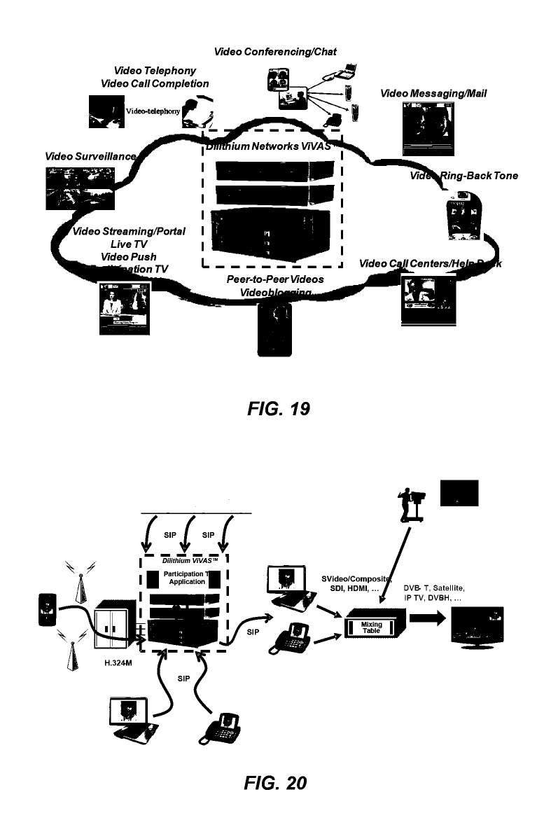

Embodiments provide a Participation TV service and platform. Embodiments base this upon the ViVAS platform which can offer a Participation TV application that can be accessed from any 3G mobile handset and/or SIP capable device or a web based videophone (e.g. based on Adobe flash), with, in each case the ViVAS platform can be used for several video/telephony applications. FIG. 19 illustrates a single ViVAS platform offering multiple services.

The present invention can be integrated in infrastructure in a wholesaling mode, the platform being virtualized and used by several TV channels or shows, or can be acquired by an audiovisual company/broadcaster for direct use.

Today, many TV channels offer a web interface to the end-users with options beyond the scope of a unidirectional channel. A benefit of the present invention is in an interactive video interface coupled to the broadcasters systems that completes the loop into the audiovisual TV medium in an audiovisual fashion. The items managed by the present invention are news (international, national, politics, sports, weather, etc), video push/alert (breaking news, notify when one team scores/a wicket falls during a sporting match, new record/gold medals during sports competitions, etc), presentation of up-coming shows/series/movies/etc, access to content related to the programs (“making of”s, interviews, people opinion, etc), live TV connection including possibility to participate during the shows, connection to live “CAM”s, media recording and storage (message, opinions, etc), communities around interest/TV-series/shows/etc, voting, games (quizzes, etc), music (clips, artist interviews, awards abstract, etc), services (dating, show reservation, etc), etc.

FIG. 20 shows connections between various elements of the participation TV solution. Moderators and assistants can discuss with the different callers (InterActors) while a video, or other IVR features, like games, are presented to callers (a virtual waiting room).

The call of a selected person can be diverted to a SIP client embedded in a PC or hard phone connected to a production mixing table with video output. The video received from the PC or the hard phone is mixed with video from a studio (such as a presenter/host) at the mixing table. The output can be broadcast to TV receivers using DVB-T, Satellite, IP, DVB-H, etc. It is also possible that there is no actual studio, but a virtual studio and mixing table exist, and even the host is actually an InterActor, or a computer generated character.

The present invention can use some or all of the following additional interfaces: 3GP files on a file system (location customizable) for storage of recorded media files; SDI, S-Video/Composite, Component, HDMI, etc. for delivery of generated content; CLI or HTTP (SMS possible through SMPP GW & email through SMTP GW) for interface for video push; RADIUS, Text CDR & HTTP for billing.

When a call/session is established to an InterActor using a mobile video terminal, there is a negotiation phase where session characteristics are established. In this phase depending on known properties of the video mixing output certain properties of the session may be modified or preferred. For example the mixing deck might use MPEG2 video in which case it would make sense to try and establish a videotelephony session using MPEG2 video (to avoid transcoding cost by allowing greater re-use of coded information from one side to the other). Likewise MPEG4-Visual and H.264 might be a used mixing side codec and hence a preferred codec to minimize transcoding on the reception side on the videotelephony session. The resolution of the media might also be up-scaled or temporally modified, interlaced etc, in order to convert it to an appropriate input form for the mixing table. Different spatial and temporal resolutions such as SQCIF, QCIF, CIF, 4CIF, SIF, 1080I/P (interlaced/progressive), 720I/P, standard def, NTSC or PAL or varying frame and field rates.

Transcoding between video telephony sessions to video “mix-ready” output likewise has similar aspects that might need to be addressed. In some cases it may actually be useful to use a special set of encoding parameters to ensure that there is no additional delay introduced from the mixer back to the InterActor. For example, multiple reference frames may be avoided on the mixer side encoder as they are not usable on the InterActor side. Also in the conversion from one side to the other, the video may also be cropped in order to provide a smaller usable portion of media.

Additionally the mixing lay out can be suggested/aided or simply provided with options and information from the incoming feed. For example caller information could be used to determine a name associated with the caller. Other information can also be provided such as automatically detecting cell information, or access point information, or receiving LBS (location based system) information from the device, the network or an application, or alternatively deriving geographic information based on other known information, such as an IP address, or from IP addresses along the route between the two devices.

Any of this additional information such as name, location or profile of the user can then be associated with the image/video of a user, such as a caption below their image. Any such information could be overridden by a management system/moderator, or even corrected by the user themselves in updating their profile either online or in an IVR. The profile information may also be used to indicate aspects of a contestants profile, which may be used in competition or for status (i.e. points scored, number of correctly answered questions, number of appearances, other viewers or interactive participants' thoughts/votes on the worthwhile nature of their comments). The additional information can be provided in various ways, and one such way is in the use of SIP meta information.

The system can also add closed captioning, using an ASR (automatic speech recognition) module on the audio signal and providing either a closed caption version of the speech or a translated version of the speech in a meta feed to the mixing table. The speech may be translated to text, or may be further translated to a spoken version using a TTS (text to speech) module. Any ASR performed can also be used to provide transcripts for the show, which are tagged more readily with the speaker in this participation platform than others.

In addition, the system could also do speaker verification (SV) and verify that a speaker is who they claim to be to help avoid prank calls or simplify the moderator's “gatekeeper” tasks. Verification may also be profile based using a personal identification number (PIN) or some other recognition factor (such as called line indication).

On the mixing/broadcast side meta information can also be carried in various ways not limited to SDI ancillary data or custom/proprietary interfaces, including for example standardized protocols used in concert with the video output (e.g. SDI and SIP terminating at the mixer).

An IVR platform can be used to perform a significant amount of the preparation work for admission to the show (i.e. capture names, ask background questions, store them for quick clips for later editing and/or display). It can also serve to provide all queuing/waiting room functionality and can server to keep people entertained whilst awaiting an interaction opportunity. The IVR may employ picture in picture to feed back the current state of the broadcast to all in the waiting room.

Moderation of each of the InterActors could take place in a few ways and a several different levels. For concerns on the suitability for broadcast of the users a moderator might have access to a squelch/censor button for each participant (or all participants) [typically the actual broadcast to non-active participants will be on a few seconds of studio delay]. The censoring might also be automatically performed via ASR and may avoid key words, such as expletives or topics that do not further a debate.

When a mixed stream is transmitted from the mixing table it may provide a separate audio stream for each participant (with their own audio contribution removed) and one for the passive viewer with all participants' contributions present. This requires additional connections and may be preferable in circumstances only when the mixing table is connected via non-channel-dedicated links (i.e. shared single connection).

If this is not the case, then a single mixed signal that is the same as that that will be broadcast to passive viewers may be fed to a portion of the system that has access to the contributing signal also. Then for each participant a cancelling filter may be run over the mixed audio, and also can use the input by that participant, and produce a filtered signal that does not contain a self echo.

One embodiment of the present invention is a platform supporting a quiz game that is partially controlled by DTMF that is also integrated into the mixing system. When an InterActor presses a button, UTI or DTMF, to answer a question (or indicate they know an answer) then the first to press might. When the indication is received, then the mixing provides a flash of the screen and highlights the contestant that has indicated most quickly. The highlighting might be via an animation or a simple color surrounding the InterActor with the right to answer.

In some embodiments a round trip measurement for each InterActor/contestant is taken and each indication is normalized based on the delay at the server to ensure that the network does not add any advantage to a particular user. This will add to the fairness of the competition and might provide for increased uptake.

A further embodiment of the present invention is in its use as a video meeting place that has a passive outlet as well as many active inputs, which is a good way of conducting round table forums with a few active but many passive participants.

In some embodiments and depending on the broadcast format, there may also be options for InterActor expression of various kinds. They may choose to have their media processed to be in sepia tones, or may choose to have their media represented by an avatar or have a theme applied to their media. These additional expression options could be further charged in a revenue sharing arrangement with an operator, or could be directly based on a profile associated with customization/personalization options or preferences.

In some embodiments the participation platform may also have tolerance to certain error cases that may occur in the InterActor's session. One error might be the case of an InterActor travelling out of video coverage (or crossing a threshold of signal quality and executing a voice call fallback [SCUDIF]). In this case the participation platform might present a stock photo, or a last good frame (possible stored in a double buffered reference frame), and retain that good image on screen whilst transmitting the voice only. Also, the option of having pre-provided an avatar, especially a life like avatar, either in the SIP negotiations or in a pre-defined/pre-configured step, would allow the fallback to be to a more realistic and pleasing experience.

The provisioning of the avatar may be associated with one or more SIP session setup parameters, for example a P-Default-Avatar might be referenced in a SIP session setup that would allow for a customized or personalized avatar.

A less drastic error case for the session, is a corruption on the incoming interface. This may lead to a degraded quality or lasting corruption of the output video if not dealt with (when the video uses temporal prediction as is expected in telephony and communications systems). The transcoding in the gateway/participation platform could employ an error concealment module to minimize the visual impact of the error (spatial/temporal or hybrid EC are possibilities). This would minimize the impact, if the data loss was drastic and the corruption significant then a covering mechanism could be employed (as described previously such as using the last good frame on freeze). Alternatively, an apology for the reduced quality could also be superimposed.

Additionally tagging of the material may also be added in either a negotiated, pre-defined, or preconfigured way (using a piece of information as a look up, such as CLI or SIP URI or email). In this way the system might automatically be able to determine the nature of a piece of material and tag its ownership accordingly (i.e. public domain/creative commons or owned/copyrighted material).

In some embodiments of the present invention the IVR in the participation platform can provide referenced/tagged ready-made clips where the InterActor is recorded answering questions through simple scripted (or dynamic) questions answered in a “video form” for lead up to interviewing, and to have these stored in an easily accessible format, for either automatic retrieval and playback or for retrieval by a studio production expert. This question set may also form part of the selection process for the characters, with keywords being an aspect in the selection of particular InterActors.

According to embodiments of the present invention the following aspects are provided. Defining access control facilities to the user so multimedia content access privileges can be defined. Defining digital rights management of created content to control multimedia distribution (redistribution). Presence service such as service presence or user presence monitoring. Content modification and manipulation (The ability to modify and manipulate multimedia content through editing facilities. Operations could include appending content to other content, deleting sections of content, inserting section of content, amongst others). Content re-interpretation or conversion (e.g., recognition of voice into text, and further text into voice). Content archiving and metadata addition for archive, rapid search and indexing purposes. Watermarked content delivery and archiving where watermarks could be predefined or custom defined (e.g., by the means of DTMF) for content marking for archiving purpose or for services such greeting videos. Addition of meta information or tagging is provided is some embodiments. Such meta information includes, without limitation, keywords, descriptions, or additional information pertinent to the media such as subtitles or additional information regarding the location of a device at a time of transmission (e.g., Location Based Services information, GPS coordinates/longitude/latitude/altitude or a wireless access point identifier such as a cell identifier or a wireless LANs location or even its IP address that can be used with additional services to retrieve a location). Content overlay to allow desired information such as video overlaying with user inputs, instant messages, emails, pictures and subtitles converted from voice recognition for live and/or offline sharing.

Embodiments of the present invention provide an ability to a news network allowing “crowd sourcing” whereby news media feeds are not provided not only by the news network's camera crews, but instead by people already on the scene with video capable devices. The media sourced in this manner could then possibly be paid for with conventional means, or micro-credits, or simply by tagging the clips with the supplier's identification.

The service, including these exemplary services, can be delivered in various ways. One way is through an architecture that consists of a videotelephony gateway terminating videotelephony calls and bridging the call to a multimedia server for participation. The architecture is one of many possible ways of delivering services. Other architectures may combine the gateway and the server (server terminates the calls), or the server may be distributed further in functionality, or all parts may be collocated. Some approaches may be more attractive in some respects including cost, configurability, scalability, interfacing with existing network components and system, and the like.

In the case of participation control, the control by handsets can be done in band (e.g., data over dedicated logical channel, standard signals or messages), out of band, or a combination. Control information can be communicated, for example, using Dual Tone Multi Frequency (DTMF) or user input indications (UTI) possibly over a control if it is available (e.g., H.245). The use of short-codes, or DTMF appended to called numbers, may be used for rapid access to the service.

Depending on the embodiment, these advantages may include no need for local storage and hence no restriction or question of running out of memory/flash disk space; access control by password or access list (e.g., white-list); and local memory can be “freed” from such activity and clips can be shared with others at any time by simply adding somebody to a white-list or providing them with a password. Additional advantages may include the processing and/or manipulation of content on the fly if desired, for example, by applying a watermark, or giving the content a theme, or using an avatar; content can be trans-sized (video frame size changed); and content can be transrated (video frame rate and/or bit rate changed); content can be transcoded on the fly (in real-time during playback). Further advantages may include an enhanced probability of users being able to provide content and participate since most 3G mobile terminals and video-calling terminals on the internet today and future can make video calls; and when a multimedia protocol such as 3G-324M (circuit-switched) is used, bit-rate efficiencies may be achieved compared to protocols such as the internet protocol as packet overheads are reduced. This is an important advantage in situations where the up-link (user to network) bit-rate is limited.

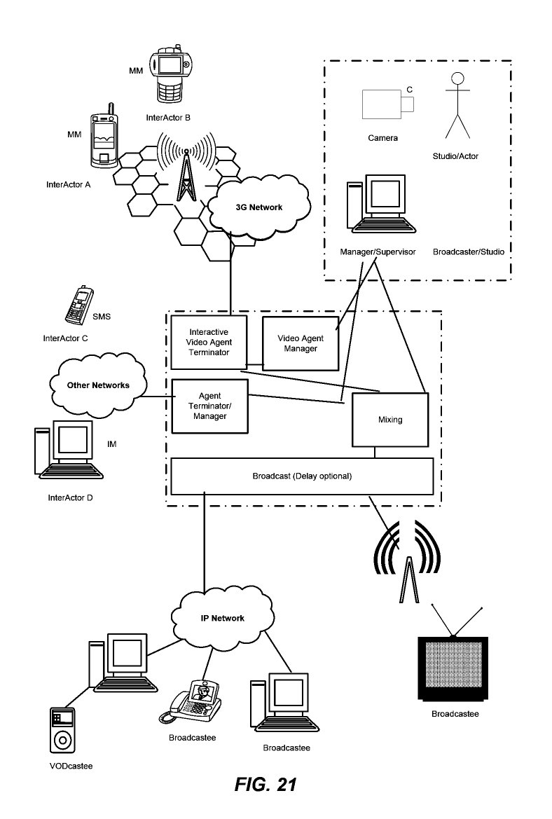

FIG. 21 illustrates a system comprising a participation platform wherein subscribers on a 3G network can connect to the participation platform in a manner similar to dialing a service. One or more users can connect at the same time if so desired, or to different sessions. In an embodiment, the terminal with InterActor A is a 3G-324M terminal and terminal with InterActor B is an IMS terminal, both of which are connected to a 3G network.

Other InterActors on other platforms may also be involved; in FIG. 21 these other platforms on same or other networks are indicated as InterActor C and D. These may or may not have multimedia content associated with them. In the illustration they are associated with text messaging or instant messaging primarily for voting, although other interactions may be available. It is also possible that the additional InterActors are involved in the studio production. In some cases it may be appropriate that a studio audience, either virtual or real, have the ability to input into the show. One such example would be asking an audience for a hint in a “Who wants to be a Millionaire?” style program. “Phone outs” to a friend or colleague are also possible in an “Ask a friend” or similar option from the same game. In this case the system may even automatically phone a particular friend based on information provided in an IVR based set of questions from the “waiting-room” of the show.

FIG. 21 also illustrates a broadcast element, which may make broadcasts of the program under production to a variety of broadcastees. A delay may sometimes be inserted in order to ensure that regulatory or other factors are met and that any content unfit for content can be protected from broadcast. This will help to avoid InterActors from intentional or inadvertently through “wardrobe malfunctions” and the like cause offensive or undesired or unfit for broadcast material from being broadcast.

FIG. 21 also illustrates a various aspects in the “Studio” of the broadcaster, which may be a single physical place, multiple physical places or a selection of virtual places. The studio is responsible for broadcast production and may have such aspects as a show host in an actual studio with a camera, or via an InterActor link/feed. The studio production entity, either software or actual people, also provides for management/supervision and moderation of the show and its InterActors. The management platform is provided in a system that may be linked to the IVR and queuing system and can allow for participants to enter based on scripted outcomes or a person selection.

In an example call flow the InterActor's call is routed to the participation platform (PP), which may transmit a greeting message and an interactive selection menu. The selection menu could be fixed or programmable through a provisioning system (e.g., through a WEB portal), this provisioning could be performed by the broadcaster, the user, or in concert between the two or another interested party. Depending on revenue share and marketing arrangements, other parties may also be involved such as service providers (network operators) and corporate sponsors. The selection menu may be triggered on demand. The menu may be programmed in a scripted language for interactive response, such as VXML/VoiceXML (including video extensions), and may be created dynamically. Alternative menus may be created in a language such as PHP. A user may select a task (e.g., to join a service) by selecting the appropriate menu (e.g., DTMF or voice for use with Interactive Voice Response—IVR).

Further media information may be recorded by the PP, or requested by the PP from a terminal, the network or another mediation device. Examples of useful meta-data to associate with a recording may include recording/publishing time and geographical or network specific information. The description above is not limited by the underlying network or transport architecture being used.

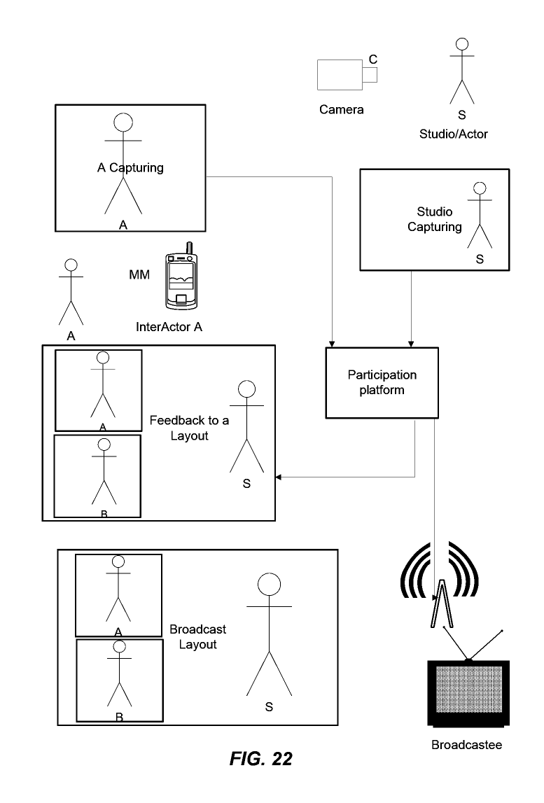

FIG. 22 is a simplified schematic diagram of service architecture scenario according to an embodiment of the present invention. Without loss of generality, we illustrate in the examples described herein the scenarios where an interactive session transmits and receives a video content through a 3G videotelephony (VT) access means, e.g. 3G-324M InterActor A. The user could send/receive content through other means, in particular a packet connectivity protocol such as SIP, H.323, HTTP, Push to Show and Video Share (IMS based SIP), RTSP (via RECORD), a proprietary protocol, a third generation multimedia communication protocol such as “H.325”/Advanced Multimedia System, a proprietary application employing on or more protocols, or APIs available in a device, or the like.

FIG. 25 illustrates an example of a possible broadcast layout that may be employed by a production involving two InterActors and a broadcast/studio feed/host as a compare. In this layout the media are position in a fashion to ensure the host can appear as though he is addressing the InterActors. Also of note is the addition of the meta content associated with the InterActors also displayed on screen. The meta information in this case, the name and the location, can be automatically determined by the participation system, possibly by receiving the information from the network either passively or actively.

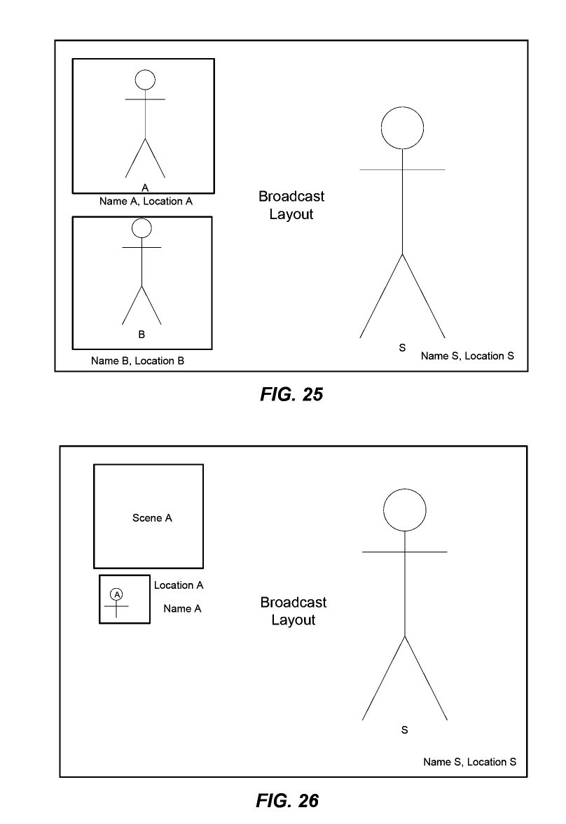

FIG. 26 show an interaction layout where a single device (or linked devices, either directly or at the media server by common identifier or the like) have two video sources closely linked, such as a reporter image and the action which the reporter is reporting on. The two coupled video channels are transmitted from the InterActor and in some embodiments the primary interest piece “Scene A” is given priority (more spatial real-estate) than that of the secondary camera showing the reporter which is also displayed. It is also possible that these two channels are coupled and the primary channel is actually not a live feed but is a canned content either from a source alongside the InterActor or present in the broadcaster's network.

The transmissions of InterActor A are input to a participation platform, as are studio inputs. Both of these inputs are then mixed in some way in the platform, possibly at an automated mixing table, or also possibly by a production staff member. The feeds to the mixing table may be one of many possible formats, including S-Video, SDI and HDMI, although other interfaces are possible and expected such as component or composite video.

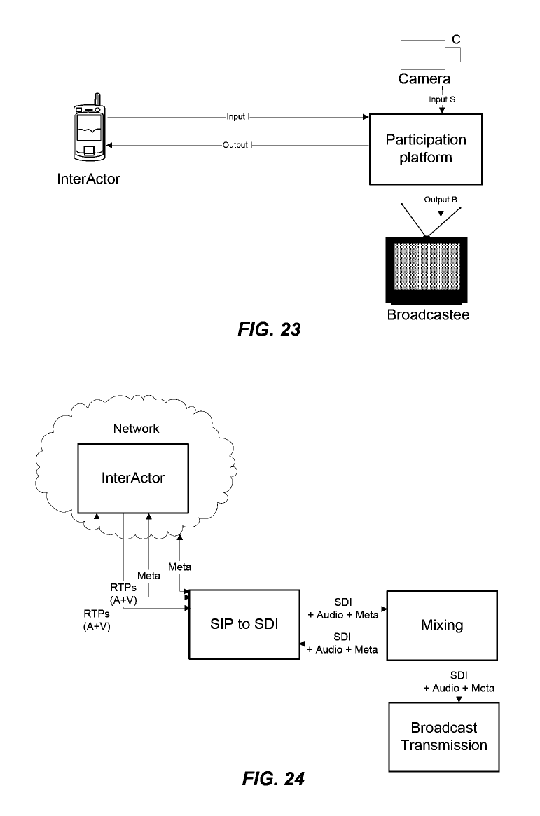

After the mixing of the media, the mixed media can be directed along two paths. One path is the expected normal broadcast path, which may have other aspects such as delay of multiple outputs depending on the intent for the content. The other path is a return feed back to InterActor A. As can be seen in the figure InterActor A receives back a mixed layout the same as the broadcast content, generally without delay, allowing them to see clearly what is happening in the broadcast feed. In embodiments, the feedback to InterActor A is performed as quickly as possible with as many elements optimized as necessary to ensure the service is acceptable. The items liable for optimization are the capture and display on the device, the network transmission characteristics, i.e. selected QoS, the mixing table characteristics and also the characteristics of the encoder and encoding option used (that may have an impact on the decoding time). The inputs and outputs from an external interface to the participation platform of the broadcaster are shown in FIG. 23.

FIG. 24 illustrates an example of some of the interfaces and/or protocols that may be used in a participation platform. In this example an InterActor is in a network and has its transmission either in RTP, or converted to RTP by an interposing element such as a multimedia gateway, a legacy breakout gateway or a media resource function of some kind. Other media transmissions are possible, although SIP is chosen here as it is a well known and accepted standard that has many pre-made applications and services using it.

The media and associated session and control signaling (if any) are then converted from a SIP session to an SDI session. The conversion may be to other media/broadcast interfaces such as S-Video/HDMI/composite or component video and the like. In this example the video is accompanied by ancillary data. The ancillary data can be many things including the audio track and/or meta information as described more fully throughout the present specification. The media and data may be converted, processed, transcoded, augmented or the like in this element as desired.

The SDI signals in this example are then delivered to a mixing platform, which may have many inputs and controls depending on the intent of the broadcaster and the program producers. After the mixing/layout forming is completed the media may be optionally broadcast. Also the mixed content is directed back to the SDI to SIP conversion element for a reverse conversion to convert from SDI to SIP session. Typically only media and some other ancillary data would cross this element. Examples of data that would likely cross this boundary might be interaction messages such as instant text, IM, T.140 and the like. Generally control would not be crossing this boundary and most control and session signaling for the SIP session is terminated on the SIP side of the element.

After the mixed content is converted into a SIP session, it is transmitted back to the InterActor and is converted as necessary through any interposing elements until it arrives at the InterActor. It is preferable that the overall delay from the transmission from the InterActor until the reception of the mixed form of the transmitted media is kept to a minimum.

In some embodiments the phones/terminals may also support some toolbox capabilities to support the broadcasting extensions while not requiring specific support for the broadcasting itself. The toolbox may incorporate the ability to download additional features and extensions. For example, the trigger of the download may be indicated by the ViVAS platform via an operator.

A user account associated with the computer server can be determined based on information associated with the 3G terminal. As an example, a user's Google Video account details, MySpace login, or YouTube registration or an account with a broadcaster or another “passport” service. The user account may be mapped from a calling party number associated with the 3G terminal. So for example, the telephone number of the calling/contributing party could be looked up in a table or database to determine the login details required to submit media associated with the user on the computer server.

Embodiments of the present invention provide for the transmission of one or more pieces of meta-information associated with the 3G terminal from the 3G terminal to the PP.

In addition to location information, the meta-information may include keywords, sometimes referred to as tags. Examples of meta-information include, without limitation, keywords, descriptions, or additional information pertinent to the media such as subtitles or additional information regarding the location of a device at a time of capture/transmission. Location information, also referred to as Location Based Services information may include GPS coordinates, longitude, latitude, altitude, combinations thereof. For some systems, a wireless access point identifier such as a cell identifier or a wireless LANs location may be provided as meta-information regarding the call. In some embodiments, the IP address of a device can be used with additional services to retrieve a location of the device.

Here an ability of the InterActor to see the direct feedback of the broadcast image, as described more fully throughout the present specification, would be substantially beneficial in order to have a more involved feeling on the narrator's part.

Additionally embodiments of the present invention are able to receive one or more pieces of meta-information associated with the wireless video terminal at the PP. The meta-information may include information such as LBS information, GPS coordinates, longitude and latitude, longitude, latitude and altitude, cell information, wireless hotspot identification, user tags, user ID, calling party identifier, called party identifier, a place identifier, an event identifier, and/or a temporal indication.

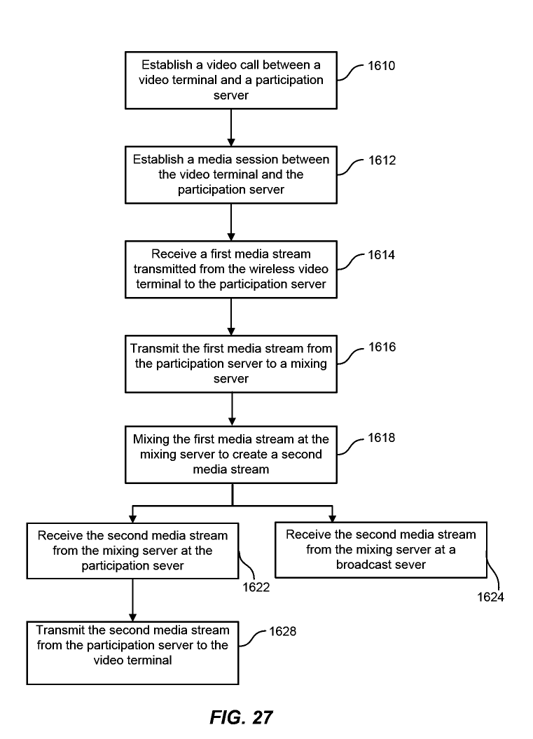

FIG. 27 is a simplified flowchart of a method of communicating media using a multimedia terminal, such as a 3G terminal, according to an embodiment of the present invention. Referring to FIG. 27, the method includes receiving, at a PP, a request to establish a communication link between a 3G terminal and the PP and establishing the communication link between the 3G terminal and the PP. Media is the transmitted on the communication link from the 3G terminal to the participation server. The participation server then mixes the media creating a second stream of material that is either for broadcast, or is possibly useful in helping a user at the 3G terminal contribute to the broadcast. The second media can then be broadcast to a receiver that is more passive than an interactive party, such as a TV viewer. The second media, or a slightly different version of it as suitable for production purposes, is transmitted to the participation server. The participation server may then modify the media in some way, such as echo or audio canceling, re-formatting for purpose and then transmits the media to the 3G terminal.

Embodiments of the present invention provide the supplementary services for completeness such as O&M & SNMP features, billing servers for event based pushes and provisioning at ViVAS or in the HLR.

Embodiments provide a combination of CS and IMS service (CSI) video blogging video value added service. An embodiment of the present invention allows providing the video blogging service on ViVAS. It allows people to instantly create and post user generated multimedia content and share the content with other people. It enables users to connect instantly with friends, families and an entire community of mobile subscribers. The key features of video blogging include recording a video, reviewing the recorded video, updating and storing the recorded video, real-time transcoding as required and immediate accessing to content without buffering effects, accessing via operator designated premium number, browsing through menus using terminal keypad for generating DTMF keys, and requesting selected video clip. The establishment of the service can be on ViVAS via the service creation environment. The provision of the service can be over IP or circuit-switched bearer networks.

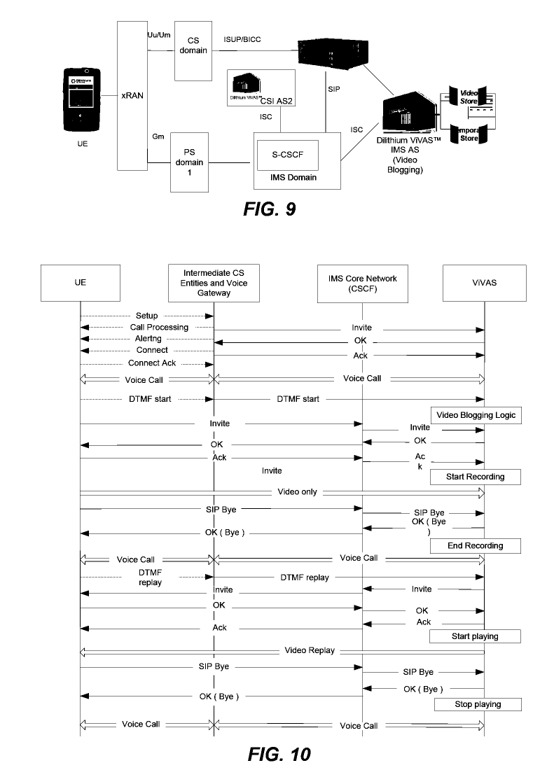

FIG. 9 illustrates another embodiment providing the video blogging service on ViVAS over CSI. It allows saving of the overall audio and video bandwidth resources. In this approach, an audio session is established over a circuit switched bearer between a video capable terminal and ViVAS. A video session is established over an IP network between a video capable terminal and ViVAS. The two video capable terminals may be the same terminal or two different physical endpoints. The two sessions are associated together as the same session.

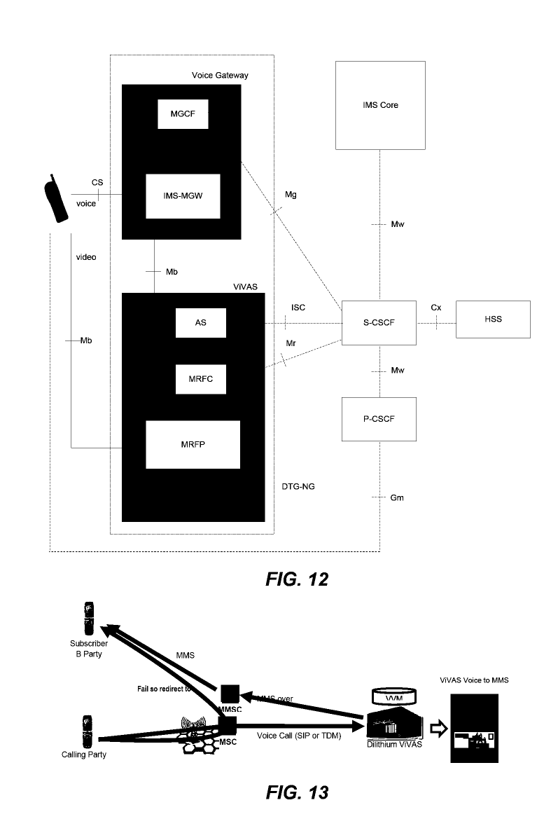

The CSI based IMS has six major components, including UE terminals supporting simultaneous CS and PS domain access, xRAN(e.g. GERAN and UTRAN), CS core, PS core, IMS core, and application server. FIG. 12 illustrates an architecture of the CSI video blogging. A mobile handset terminal establishes a CS voice session via the MGCF of a voice gateway and over the S-CSCF into the application server (AS) of the ViVAS platform. The CS voice channel is established with the media server (MRFP) of ViVAS via the voice gateway (IMS-MGW). The DTMF keys are transmitted from the mobile handset terminal to ViVAS via the voice channel. The mobile handset terminal establishes a video session with the application server (AS) of the ViVAS platform via P-CSCF and S-CSCF. The IP-based video channel is established with the media server (MRFP) of the ViVAS platform over an IMS network.

A video channel is established when necessary. The video channel is established from the mobile handset terminal to ViVAS when the mobile handset terminal user records content into ViVAS. Video channel is established from ViVAS to the mobile handset terminal when the mobile handset terminal user reviews the recorded content or browse the contents generated by other people.

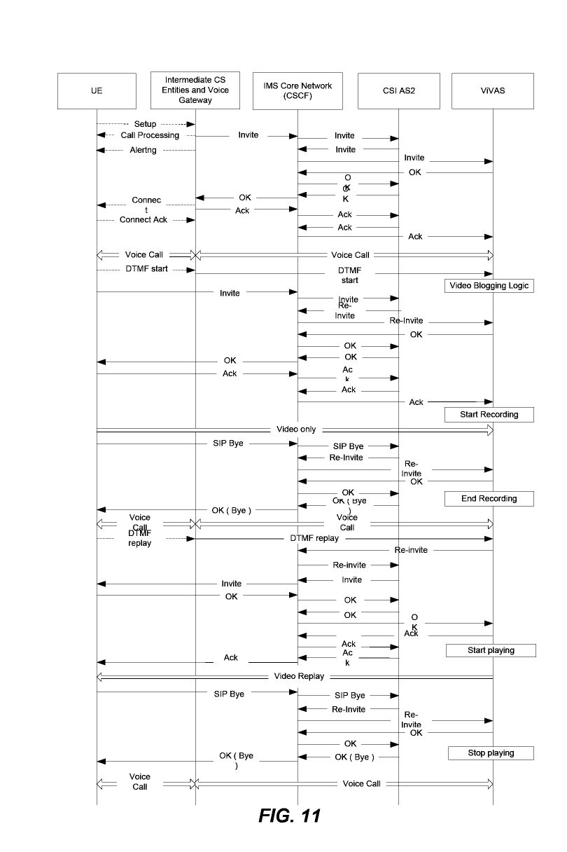

FIG. 10 illustrates an overall call flow of establishing an IMS CSI video blogging session on the ViVAS platform. FIG. 11 illustrates a call flow of establishing an IMS CSI video blogging session. CSI AS is a core component of CSI IWF, and one of the functions of the CSI IWF is to combine CS and IP to IMS session.

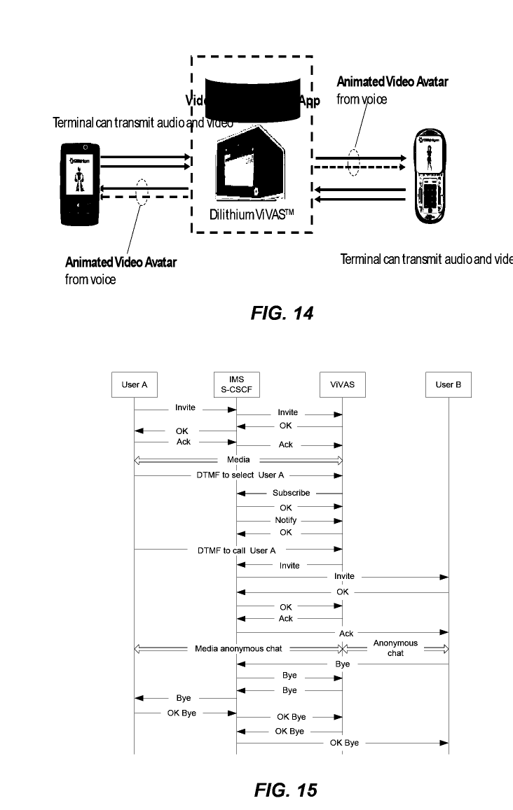

Embodiments provide an IMS video chat service on the ViVAS platform. Video chat services can be varied in alternative embodiments. One variation is the anonymous video chat. In a video call, users of the video chat service can hide their actual appearance by using replacement video. The replacement video can be a picture, a photo, a movie clip, a static avatar or a dynamic avatar. Users may configure the avatar settings and the video contents according to the caller phone number, the called phone number, date and time of the call, their online presence status, which also allows the users to hide their identity as well. The online presence status may be determined from IMS presence service. At any time during the call session, users may switch the type of avatar or live video using DTMF from the terminal keypads. For the video chat service with avatar, avatars can be categorized as standard and premium. FIG. 14 illustrates one working principle of the video chat service with ViVAS. FIG. 15 illustrates a call flow of the video chat service with ViVAS.

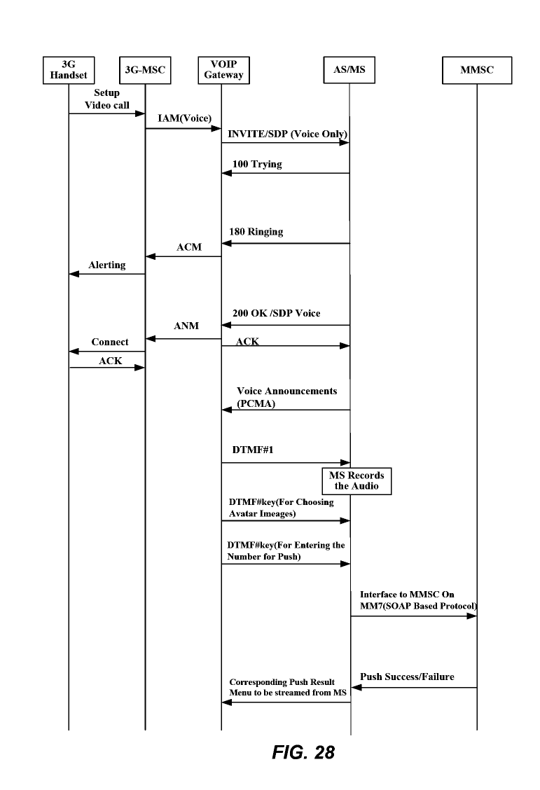

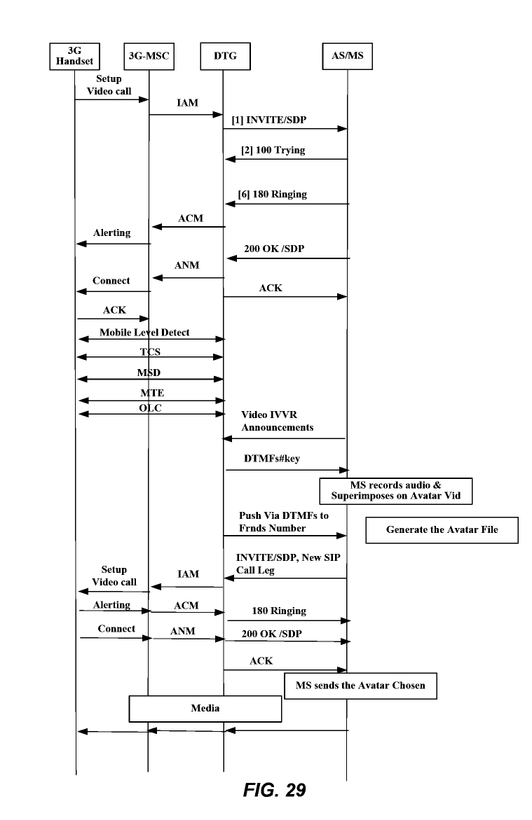

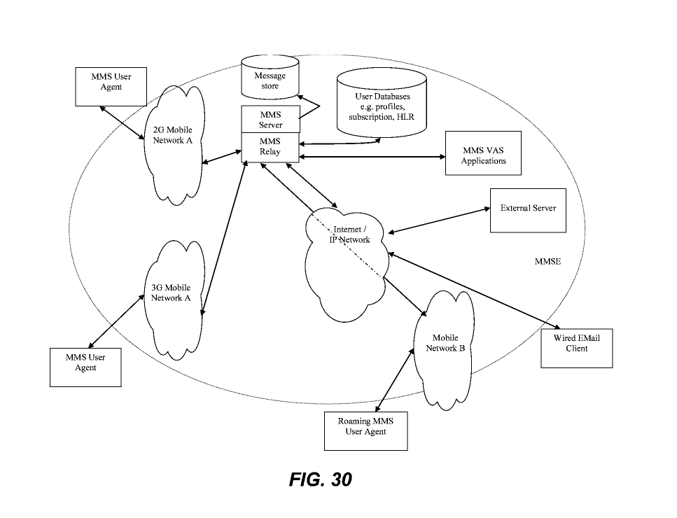

Embodiments provide a video MMS creation service from a voice message on the ViVAS platform. When a user calls to another party and another party is unavailable, the conventional approach is to leave a voice mail to a voice messaging center. With the video MMS service, the caller is still offered to record a voice message. Rather than the recorded voice message being deposited at the voice messaging center, the voice message is further processed to be converted into a media clip which is further sent to the other party as an MMS message. With this approach, the recorded message also may not need to be stored on the voice messaging center. FIG. 28 and FIG. 29 illustrate call flows of two variations of the embodiments of the video MMS service.

Embodiments of the present invention provide an interface to an MMSC from ViVAS. The Interface to MMSC from ViVAS can be MM7. MM7 is a SOAP Based Protocol to communicate with an MMSC Server. FIG. 30 is a diagram illustrating a network according to an embodiment of the present invention. The video MMS service can be transformed into more advanced service applications by those skilled in the art.

Embodiments provide for voice IVR with video overlay. A variation of video MMS is to enhance the voice message to a media clip by providing additional video contents to form an overlay over the voice message. FIG. 13 illustrates an embodiment of the video MMS service. For this service, the caller (party A) is in the 2G network. When making a call to the callee (party B) and the callee is not available, the caller is redirected to a voice mail. After the voice mail is left to the system successfully, the application converts it with video to form a clip, which will then be delivered to the handset of the callee as an MMS. The video can be advertisement, messages, movies, or avatars. This allows video MMS to offer enhanced subscriber experience beyond conventional voice mail system.

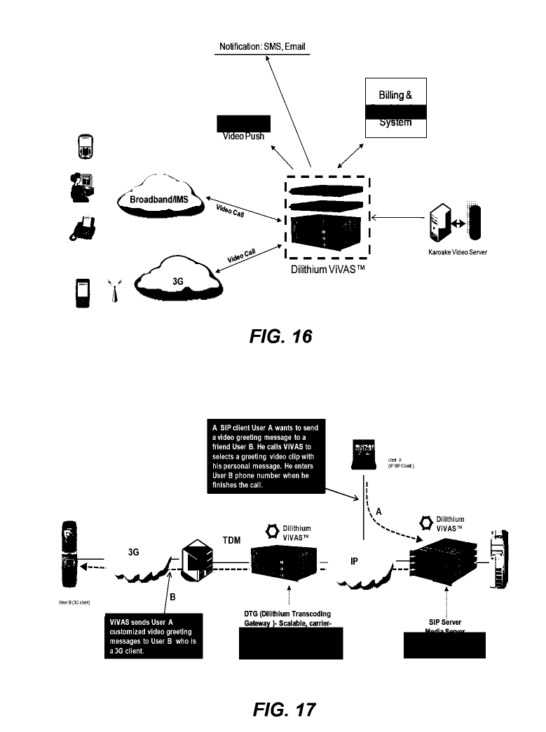

Embodiments provide a video karaoke service. Karaoke is a popular entertainment activity across several age groups, in particular in Asia. An embodiment of the present invention provides a video karaoke service on the ViVAS platform. The service is capable of delivering video karaoke service to a mobile or fixed terminal. To use the video karaoke service, a user dials karaoke number. The user selects a song or lyrics from a visual menu. The visual menu groups the song and lyrics by song category, song title, and/or singer name. The user watches the lyrics/visual and sings. The user can stop and review the recorded singing. The user can accept and share the video clip that includes the user's voice and the background music and/or video. FIG. 16 illustrates an embodiment of video karaoke.

Embodiments provide a video greeting service which is a greeting message forwarding service, where the message is selected from a user selection to be delivered to a handset terminal of another person by the ViVAS platform. FIG. 17 illustrates a connection architecture of a video greeting service provided by ViVAS. A user dials a service access phone number for the video greeting. The call reaches the ViVAS platform and the user is offered to specify a destination phone number that the message is delivered to, and select a greeting video message available on the platform. Once the message selection is confirmed, the ViVAS platform pushes the message to the phone of a user specified by the calling user.

The video greeting service can be festivity oriented. One of ordinary skill in the art would recognize many variations, modifications, and alternatives of the video greeting service. For example, a variation of the embodiment for the video greeting service enables the greeting message delivery to be further enhanced from video push. If the recipient phone number is not reachable, the message can be delivered as an MMS message. Another variation of the embodiment provides text to MMS service on the ViVAS platform. ViVAS accepts an incoming SMS message. The message input by a user indicates the recipient phone number, the contents of the message in text form and the preferred visual content to be used, such as an avatar or a movie clip. The message will be processed by a text-to-speech conversion module to form a voice content. Optionally, a video content can be combined into the voice content. The video content can be an avatar, a movie clip, etc. The prepared multimedia content can then be delivered by the ViVAS platform to the destination phone as an MMS message.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein.

The previous description of the preferred embodiments are provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein. For example, the functionality above may be combined or further separated, depending upon the embodiment. The system can also be extended to adopt proprietary protocols. Certain features may also be added or removed. Additionally, the particular order of the features recited is not specifically required in certain embodiments, although may be important in others. The sequence of processes can be carried out in computer code and/or hardware depending upon the embodiment. Of course, one of ordinary skill in the art would recognize many other variations, modifications, and alternatives.

Additionally, it is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A multimedia multi-service platform for providing one or more multimedia value added services in one or more telecommunications networks, the platform comprising:
one or more application servers configured to operate in part according to a service program;
one or more media servers configured to access, handle, process, and deliver media;
one or more logic controllers; and
one or more management modules.

2. The platform of claim 1 further comprising one or more multipoint control units coupled to the one or more logic controllers.

3. The platform of claim 1 further comprising one or more web servers.

4. The platform of claim 3 wherein the one or more application servers, the one or more web servers, and the one or more management modules physically reside in a same enclosure.

5. The platform of claim 1 wherein the service program comprises a script.

6. The platform of claim 1 wherein the service program comprises an output of a service creation environment provided by the multimedia multi-service platform.

7. The platform of claim 1 wherein the one or more media servers are capable of performing one or more of media transcoding, transrating, or transizing from a first media format to a second media format.

8. The platform of claim 1 further comprising one or more multimedia gateways that are capable of connection between a first communication network and a second communication network.

9. The platform of claim 8 wherein the first communication network comprises a packet-switched network and the second communication network comprises a packet-switched or circuit-switched network.

10. The platform of claim 8 wherein the first communication network comprises one of a 3G network or an IP network.
